(19) United States
(12) Patent Application Publication
(10) Pub. No.: US 2016/0105407 A1
(43) Pub. Date: Apr. 14, 2016

(54) INFORMATION PROCESSING APPARATUS, TERMINAL, INFORMATION PROCESSING SYSTEM, AND INFORMATION PROCESSING METHOD

(71) Applicant: FUJITSU LIMITED, Kawasaki-shi (JP)

(72) Inventor: Toshiro OHBITSU, Akishima (JP)

(73) Assignee: FUJITSU LIMITED, Kawasaki-shi (JP)

(21) Appl. No.: 14/973,248

(22) Filed: Dec. 17, 2015

Related U.S. Application Data
(63) Continuation of application No. PCT/JP2013/067919, filed on Jun. 28, 2013.

(51) Int. Cl. H04L 29/06; H04L 29/08

(52) U.S. Cl. CPC H04L 63/061; H04L 67/1097; H04L 63/0457; H04L 63/0876

(57) ABSTRACT

An information processing apparatus includes a storage that stores status data indicating past usage of an access point by a terminal and a processor that executes a process. The process includes receiving encrypted status data via a network from the terminal, decrypting the encrypted status data received from the terminal, determining whether the decrypted status data is valid based on the status data stored in the storage, and when the decrypted status data is valid, establishing a peer-to-peer communication channel with the terminal via the network.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2013/067919, filed on Jun. 28, 2013, the entire contents of which are incorporated herein by reference.

### FIELD

An aspect of this disclosure relates to an information processing apparatus, a terminal, an information processing system, and an information processing method.

### BACKGROUND

Japanese Laid-Open Patent Publication No. 2006-094041, for example, discloses an electric apparatus including an Internet-connection function. The electric apparatus includes a NAT control unit that controls a network address translation (NAT) router, which converts a global IP (GIP) address into a private address and vice versa, so that packets can be delivered to the electric apparatus and obtains configuration information and the global IP address of the NAT router; and a NAT configuration information reporting unit that reports the configuration information and the global IP address of the NAT router obtained by the NAT control unit to a server on the Internet.

Re-publication of PCT International Application Publication No. 2007-043381, for example, discloses a network communication apparatus that is connected to a network and communicates with other network communication apparatuses via NAT routers having an address conversion function. The network communication apparatus includes a direct search unit that sends a direct search request to another network communication apparatus that the network communication apparatus desires to communicate with; a route address obtaining unit that obtains, from an address management apparatus connected to the network, route addresses including addresses of NAT routers in a route between the other network communication apparatus and the address management apparatus; a route obtaining unit that compares the route addresses obtained by the route address obtaining unit with route addresses in a route between the network communication apparatus itself and the address management apparatus to obtain a route between the network communication apparatus and the other network communication apparatus; and a communication control unit that communicates with the other network communication apparatus based on information on the other network communication apparatus when the information is obtained via the direct search request, and communicates with the other network communication apparatus based on the obtained route when the information is not obtained.

Japanese Laid-Open Patent Publication No. 2007-312148, for example, discloses a home gateway apparatus connected via a network to an external apparatus and an external gateway apparatus. The home gateway apparatus includes a storage unit that stores information regarding a predetermined apparatus, and an access control unit that controls access to the external apparatus. The access control unit obtains the information regarding the predetermined apparatus from the storage unit, and sends the obtained information to the external gateway apparatus. When the external gateway apparatus determines that information obtained from and regarding the external apparatus corresponds to the information regarding the predetermined apparatus, the access control unit performs a control process to communicate with the external apparatus without passing through the external gateway apparatus.

### SUMMARY

According to an aspect of this disclosure, there is provided an information processing apparatus including a storage that stores status data indicating past usage of an access point by a terminal and a processor that executes a process. The process includes receiving encrypted status data via a network from the terminal, decrypting the encrypted status data received from the terminal, determining whether the decrypted status data is valid based on the status data stored in the storage, and when the decrypted status data is valid, establishing a peer-to-peer communication channel with the terminal via the network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an information processing system;

FIG. 2 is a block diagram illustrating an exemplary hardware configuration of a personal computer, a terminal, and an authentication server;

FIG. 3 is a sequence chart illustrating an exemplary initial registration process in an information processing system;

FIG. 4 is a flowchart illustrating an exemplary start-up process of an authentication application;

FIG. 5 is a flowchart illustrating an exemplary status data registration process performed by a personal computer;

FIG. 6 is a flowchart illustrating an exemplary registration process performed by an authentication server;

FIG. 7 is a drawing illustrating an exemplary ID-PW input UI of a personal computer;

FIG. 8 is a drawing illustrating an exemplary terminal selection UI of a personal computer;

FIG. 9 is a drawing illustrating an exemplary status data reception UI of a personal computer;

FIG. 10 is a drawing illustrating an exemplary terminal registration progress UI of a personal computer;

FIG. 11 is a drawing illustrating an exemplary terminal registration completion UI of a personal computer;

FIG. 12 is a drawing illustrating an exemplary PC selection UI of a terminal;

FIG. 13 is a drawing illustrating an exemplary status data transmission confirmation UI of a terminal;

FIG. 14 is a drawing illustrating an exemplary status data transmission progress UI of a terminal;

FIG. 15 is a drawing illustrating an exemplary registration completion UI of a terminal;

FIG. 16 is a drawing illustrating an exemplary unsuccessful validation UI of a personal computer;

FIG. 17 is a drawing illustrating exemplary status data stored in a personal computer;

FIG. 18 is a table illustrating an exemplary information structure of a management DB;

FIG. 19 is a drawing illustrating a first connection configuration;

FIG. 20 is a table illustrating exemplary status data generated in the case of the first connection configuration;

FIG. 21 is a drawing illustrating a second connection configuration;

FIG. 22 is a table illustrating exemplary status data generated in the case of the second connection configuration;

FIG. 23 is a drawing illustrating an exemplary connection configuration for a hybrid P2P connection;

FIG. 24 is a sequence chart illustrating an exemplary process performed to establish a hybrid P2P channel;

FIG. 25 is a flowchart illustrating an exemplary process performed by an authentication server in the process of establishing a hybrid P2P channel;

FIG. 26 is a flowchart illustrating an exemplary process performed by a personal computer in the process of establishing a hybrid P2P channel; and

FIG. 27 is a sequence chart illustrating an exemplary additional terminal registration process.

### DESCRIPTION OF EMBODIMENTS

With the related-art technologies described above, when, for example, a communication apparatus capable of establishing a peer-to-peer (P2P) connection with another communication apparatus is taken out and connected to the other communication apparatus by an unauthorized user, the other communication apparatus cannot determine whether the communication terminal is taken out by the unauthorized user, and therefore it is not possible to ensure the security of a P2P connection.

An aspect of this disclosure makes it possible to provide a communication terminal that can ensure the security of a P2P connection.

Another aspect of this disclosure makes it possible to provide an information processing apparatus, a terminal, an information processing system, and an information processing method that can ensure the security of a P2P connection.

Embodiments of the present invention are described below with reference to the accompanying drawings.

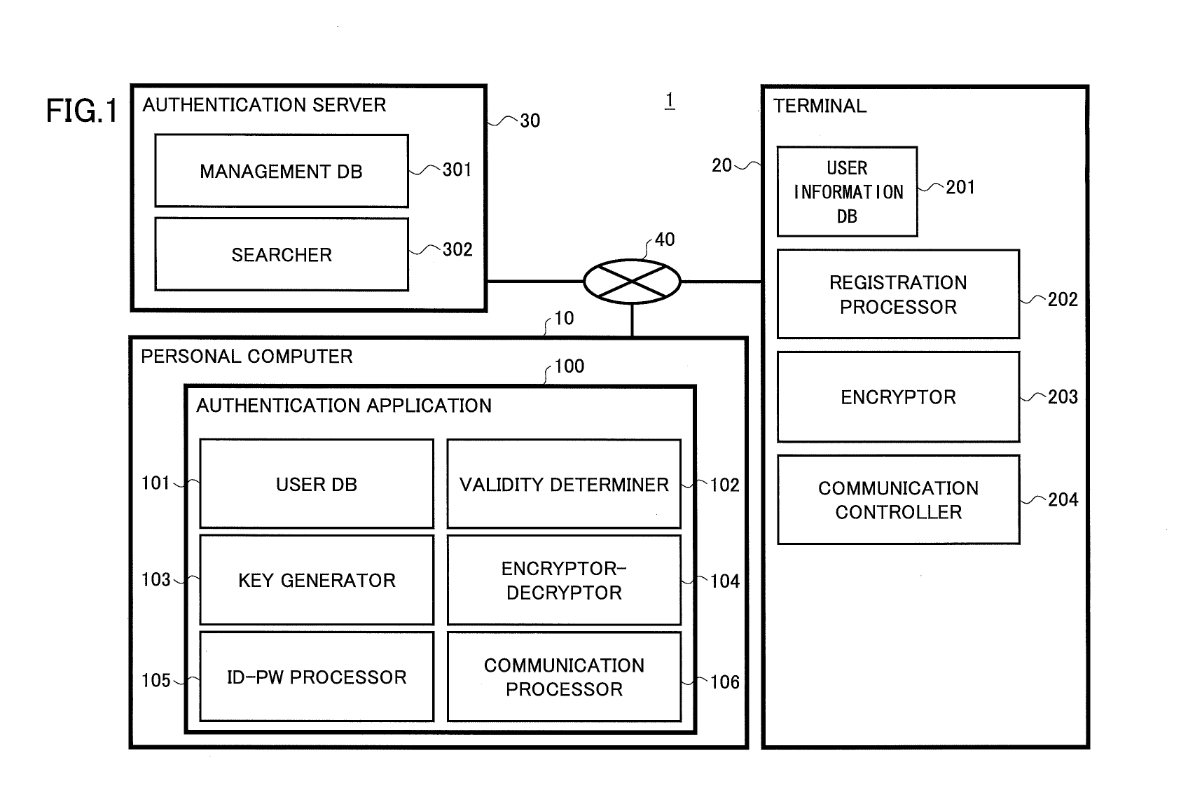

FIG. 1 is a block diagram illustrating an exemplary functional configuration of an information processing system 1. As illustrated by FIG. 1, the information processing system 1 may include a personal computer (PC) 10 that is an example of an information processing apparatus, a terminal 20, and an authentication server 30. The personal computer 10, the terminal 20, and the authentication server 30 are connected to each other via a network 40 to be able to communicate with each other.

In the present embodiment, it is assumed that the personal computer 10 and the terminal 20 perform hybrid P2P communications via the network 40 by using the authentication server 30 as an address resolution unit.

In P2P communications where data is sent and received between networked computers connected directly to each other, it is necessary to obtain a destination Internet protocol (IP) address to establish a communication channel between the computers. However, when, for example, a dynamic host configuration protocol (DHCP) is used, IP addresses are automatically assigned to computers, and the assigned IP addresses change. For this reason, in a hybrid P2P connection technology, an index server having a global IP (GIP) address is provided on a network, and the index server performs address resolution by sending IP address information of a destination computer to a source computer that has tried to connect to the GIP address.

The personal computer 10, the terminal 20, and the authentication server 30 are computer systems having a hardware configuration as described later. The functional blocks in FIG. 1 are implemented as software modules of a computer system. However, the functional blocks may also be implemented by dedicated hardware components. Also, multiple functional blocks may be implemented by one software module, or one functional block may be implemented by multiple software modules.

The personal computer 10 may include an authentication application 100 as executable software. The authentication application 100 may include a user database (DB) 101, a validity determiner 102, a key generator 103, an encryptor-decryptor 104, an ID-PW processor 105, and a communication processor 106 as software modules.

The user DB 101 is an example of a status data storage, and stores status data indicating past usage of access points by the terminal 20.

The validity determiner 102 compares status data stored in the user DB 101 with status data sent from the terminal 20 to determine the validity of the terminal 20.

The key generator 103 generates a private key and a public key based on status data stored in the user DB 101.

The encryptor-decryptor 104 is an example of a decryptor, and decrypts status data encrypted with a public key generated by the key generator 103. The encryptor-decryptor 104 can also encrypt data to be sent from the personal computer 10 to another apparatus with a public key.

The communication processor 106 establishes a communication channel with another apparatus via the network 40, and sends and receives communication data to and from the other apparatus. In the present embodiment, the communication processor 106 establishes communication channels with the terminal 20 and the authentication server 30 via the network 40. Also in the present embodiment, it is assumed that the communication processor 106 can establish a communication channel both in a secure network environment and an insecure network environment with a communication controller 204 of the terminal 20.

Here, the secure network environment indicates a network that is free from intrusions and attacks from external computers and where all apparatuses connected to the network do not perform malicious activities such as unauthorized information acquisition. In the secure network environment, there is no risk of eavesdropping and alteration of communication data, and apparatuses connected to the network can safely communicate with each other without encrypting a communication channel or communication data. Accordingly, in the secure network environment, data can be sent and received via the network as plaintext.

On the other hand, the insecure network environment indicates an environment where communications are performed via, for example, a public network such as the Internet and where malicious activities such as eavesdropping and alteration of communication data and impersonation may occur. In the insecure network environment, communication data may need to be protected by, for example, encrypting a communication channel using a certificate of a secure socket layer (SSL) protocol, or encrypting the communication data using a hash function.

Details of communication data sent and received in the present embodiment are described later.

The ID-PW processor 105 performs authentication of a user of the terminal 20 to be connected via a P2P connection by using an ID and a password of the user.

The terminal 20 may include a user information DB 201, a registration processor 202, an encryptor 203, and a communication controller 204.

The user information DB 201 stores identification information of the terminal 20 and identification information of a user. For example, a media access control (MAC) address may be used as the identification information of the terminal 20. Also, depending on the type of the terminal 20, an internal mobile equipment identify (IMEI), an international mobile subscriber identity (IMSI), or an integrated circuit card identifier (ICCID) may also be used as the identification information of the terminal 20. The identification information of the user is, for example, a user ID and a password.

The user information DB 201 also stores status data including access point information on access points that the terminal 20 connected to and used in the past and an access history. The status data is to be encrypted and used for authentication as described later. The access point information in the status data indicates past usage of access points by the terminal 20 and includes, for example, IP addresses and/or IDs for identifying the access points.

The access history may include information for identifying a communication route of the terminal 20. The user information DB 201 may store an access history of the latest connection by the terminal 20 to an access point. Also, the user information DB 201 may store an access history of connections made during a predetermined time period. For example, the access history may indicate the date and time when an initial registration process described later is performed.

Further, the user information DB 201 may store an access history of a predetermined number of past connections. Unlike static identification information such as a MAC address, an access history dynamically changes. Therefore, using status data including an access history as an encryption target (seed) makes it possible to improve security.

Also, using status data including an access history makes it possible to detect impersonation where, for example, a terminal tries to impersonate the terminal 20 by using identification information such as a MAC address of the terminal 20. In the present embodiment, it is assumed that status data is stored in association with device information and user information, or includes device information and user information.

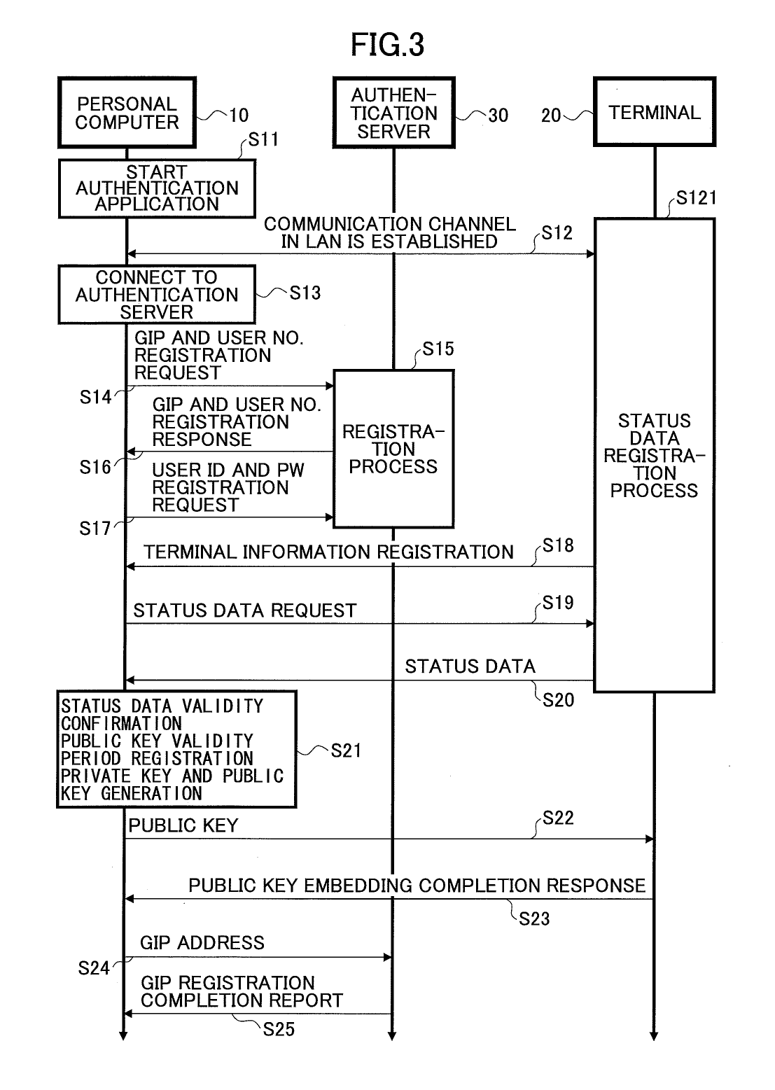

The registration processor 202 is an example of a usage registrar, and registers status data of the terminal 20. The status data registered by the registration processor 202 is sent to the personal computer 10. Details of communications between the personal computer 10 and the terminal 20 are described later with reference to FIGS. 3 and 11 through 15.

The encryptor 203 encrypts the status data registered by the registration processor 202 by using a public key provided by the personal computer 10.

The encryptor 203 receives a public key via the network 40 from the personal computer 10 in a secure network environment, and stores (or embeds) the received public key inside of the encryptor 203 itself so that the public key is available when necessary.

The encryptor 203 can use the public key received from the personal computer 10 during a validity period of the public key. The encryptor 203 can also discard the stored public key when the validity period expires. Also, the encryptor 203 may be configured to discard the public key in response to an explicit operation performed by an operator of the terminal 20.

The communication controller 204 establishes a communication channel with another apparatus via the network 40, and sends and receives communication data to and from the other apparatus. The communication controller 204 sends status data encrypted by the encryptor 203 via the network 40 to the personal computer 10. Also, when it is determined that the encrypted status data sent to the personal computer 10 is valid, the communication controller 204 establishes a peer-to-peer (P2P) communication channel with the personal computer 10.

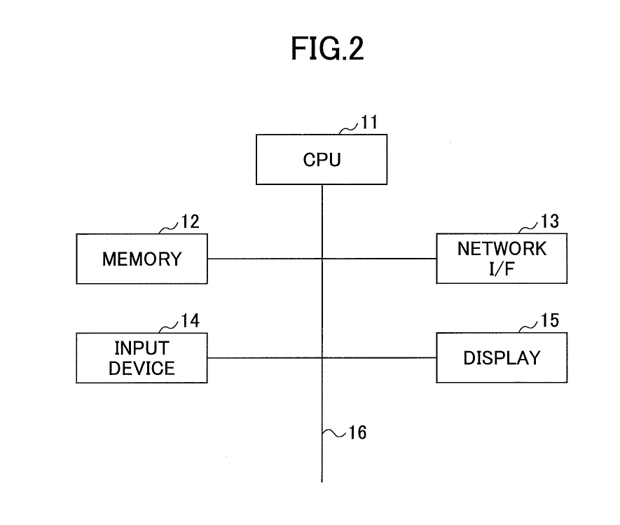

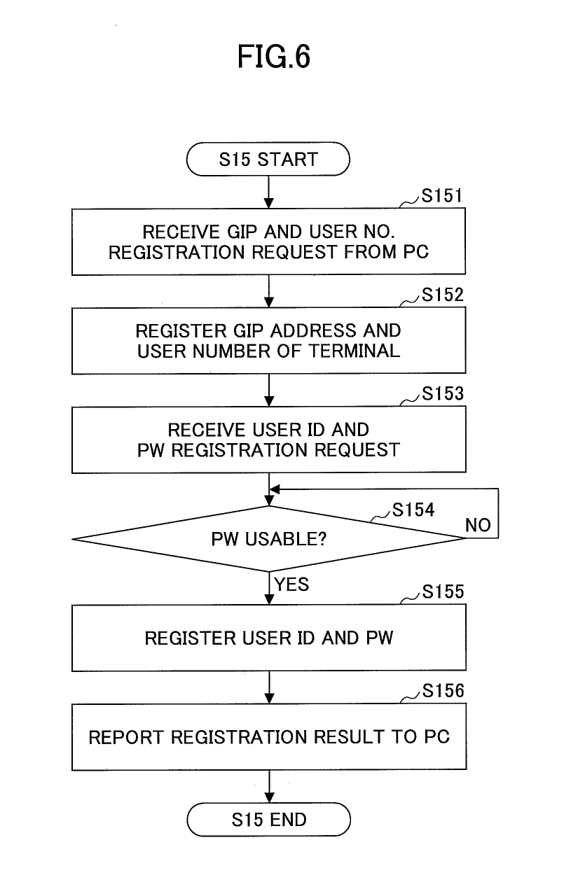

The authentication server 30 may include a management DB 301 for managing user numbers and global IP (GIP) addresses, and a searcher 302 that searches the management DB 301 based on a user ID and a password to perform address resolution. In the management DB 301, a GIP address of an access point used by the terminal 20 and a user number of a user of the terminal 20 to be connected to the personal computer 10 via a hybrid P2P connection are registered through an initial registration process described later with reference to FIG. 6. After the initial registration process, the authentication server 30 can be used as an index server that performs address resolution for the P2P connection. Data registered by the initial registration process is stored in an internal memory described with reference to FIG. 2.

FIG. 2 is a block diagram illustrating an exemplary hardware configuration of the personal computer 10, the terminal 20, and the authentication server 30. In the present embodiment, it is assumed that the personal computer 10, the terminal 20, and the authentication server 30 have substantially the same hardware configuration. Therefore, an exemplary hardware configuration of the personal computer 10 is described here, and descriptions of hardware configurations of the terminal 20 and the authentication server 30 are omitted. Also, the same reference numbers may be used to refer to the hardware components of the personal computer 10, the terminal 20, and the authentication server 30.

As illustrated by FIG. 2, the personal computer 10 may include a central processing unit (CPU) 11, a memory 12, a network interface (I/F) 13, an input device 14, a display 15, and a bus 16.

The CPU 11 controls operations of the personal computer 10. The software modules of the authentication application 100 described with reference to FIG. 1 are stored in the memory 12 and executed by the CPU 11.

The memory 12 may be implemented by a random access memory (RAM). Also, the memory 12 may be implemented by other types of storage media such as a read-only memory (ROM) and a hard disk.

The network I/F 13 establishes a connection path with another computer system via the network 40, and controls data communications performed via the network 40. The network I/F 13 may be implemented by, for example, a network interface card (NIC), and controls communications according to communication technologies such as a wired local area network (LAN), a wireless LAN, 3rd Generation (3G) Mobile Communications, 4th Generation (4G) Mobile Communications (Long Term Evolution (LTE)), and Worldwide Interoperability for Microwave Access (WiMAX).

The input device 14 may be implemented by, for example, a keyboard and a mouse. The display 15 may be implemented by, for example, a liquid crystal display.

The CPU 11, the memory 12, the network I/F 13, the input device 14, and the display 15 are connected to each other via the bus 16.

Next, an exemplary initial registration process for a P2P connection between the personal computer 10 and the terminal 20 of the information processing system 1 is described with reference to FIGS. 3 through 21. Here, it is assumed that the initial registration process is performed between the personal computer 10 and the terminal 20 in a secure network environment. Accordingly, it is not necessary to encrypt communication data sent and received between the personal computer 10 and the terminal 20 in the initial registration process.

FIG. 3 is a sequence chart illustrating an exemplary initial registration process in the information processing system 1. FIG. 3 illustrates communications among the personal computer 10, the terminal 20, and the authentication server 30.

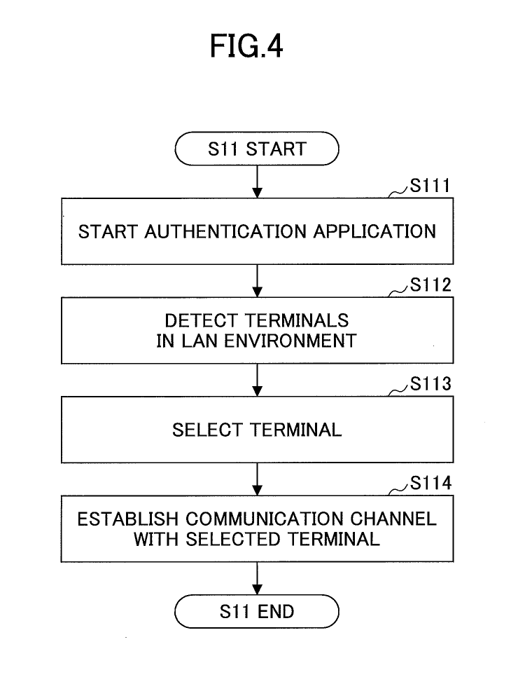

First, a start-up process of the authentication application 100 of the personal computer 10 is performed (S11). The start-up process of the authentication application 100 is described with reference to FIG. 4. FIG. 4 is a flowchart illustrating an exemplary start-up process of the authentication application 100.

As illustrated by FIG. 4, the authentication application 100 is started (S111). The authentication application 100 is started, for example, by an explicit instruction of an operator. Also, the authentication application 100 may be started by a command received via the network I/F 13.

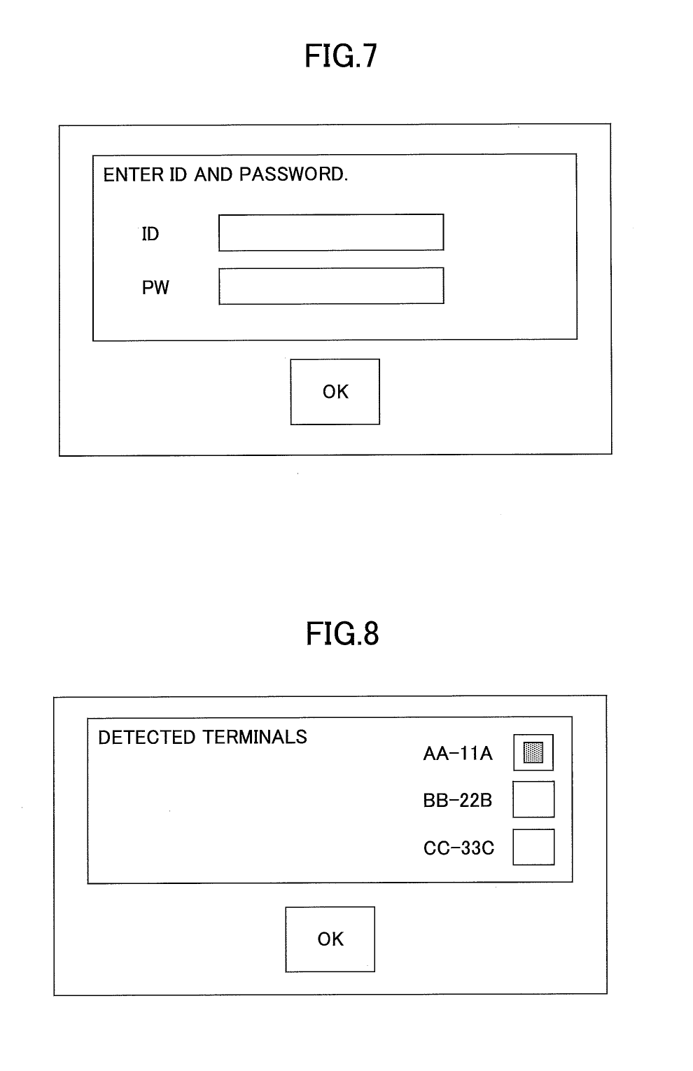

When started, the authentication application 100 requests an operator of the personal computer 10 to enter an ID and a password. FIG. 7 illustrates an exemplary ID-PW input user interface (UI) displayed on the display 15 of the personal computer 10.

On the ID-PW input UI (dialog box) of FIG. 7, the operator enters an ID and a password in the corresponding fields, and presses an OK button. The entered ID and password can be used to log into the authentication server 30.

Referring back to FIG. 4, the authentication application 100 detects terminals 20 in a search range in the same LAN environment (S112). For example, the authentication application 100 may detect terminals 20 by sending a ping message to a broadcast IP address. The search range may be defined by, for example, a subnet or a segment. However, the search range may be expanded to search for terminals 20 across multiple segments depending on the configuration of routers.

In the present embodiment, it is assumed that communications between the personal computer 10 and the terminal 20 in the initial registration process are performed in a secure network environment.

Next, the authentication application 100 selects a terminal 20 whose status data is to be registered from the detected terminals 20 (S113). Selection of a terminal 20 is described with reference to FIG. 8. FIG. 8 is a drawing illustrating an exemplary terminal selection UI displayed on the display 15 of the personal computer 10.

As illustrated by FIG. 8, the authentication application 100 displays the terminal selection UI that includes a list of the terminals 20 detected at step S112 and allows the operator to select a terminal 20 whose status data is to be registered. In the example of FIG. 8, IDs “AA-11A”, “BB-22B”, and “CC-33C” of three terminals 20 are displayed on the terminal selection UI. Check boxes are provided to the right of the IDs of the terminals 20 to allow the operator to select one or more of the terminals 20. In FIG. 8, a terminal 20 with the ID “AA-11A” is selected. The IDs of the terminals 20 displayed on the terminal selection UI may be represented by MAC addresses of the terminals 20. After selecting a terminal(s) 20, the operator presses the OK button.

Referring back to FIG. 4, the authentication application 100 establishes a communication channel with the selected terminal 20 (S114). When the communication channel with the terminal 20 is established, step S11 ends.

Referring back to FIG. 3, the communication channel between the personal computer 10 and the terminal 20 has been established in the same LAN (S12). The terminal 20 may be configured to establish communication channels with multiple personal computers 10 at the same time by, for example, establishing multiple sessions.

Communications between the personal computer 10 and the authentication server 30 at steps S13 through S17 and communications between the personal computer 10 and the terminal 20 at step S121 and steps S18 through S20 may be performed asynchronously and concurrently.

First, communications between the personal computer 10 and the terminal 20 at step S121 and steps S18 through S20 are described.

When the communication channel is established, the terminal 20 registers terminal information in the personal computer 10 (S18). The terminal information includes, for example, device information of the terminal 20 and user information including a user number and a user ID.

The authentication application 100 sends a status data request to the terminal 20 whose terminal information has been registered, to request the terminal 20 to send status data (S19). When the terminal 20 receives the status data request, a PC selection UI is displayed on the display 15 of the terminal 20. FIG. 12 is a drawing illustrating an exemplary PC selection UI of the terminal 20.

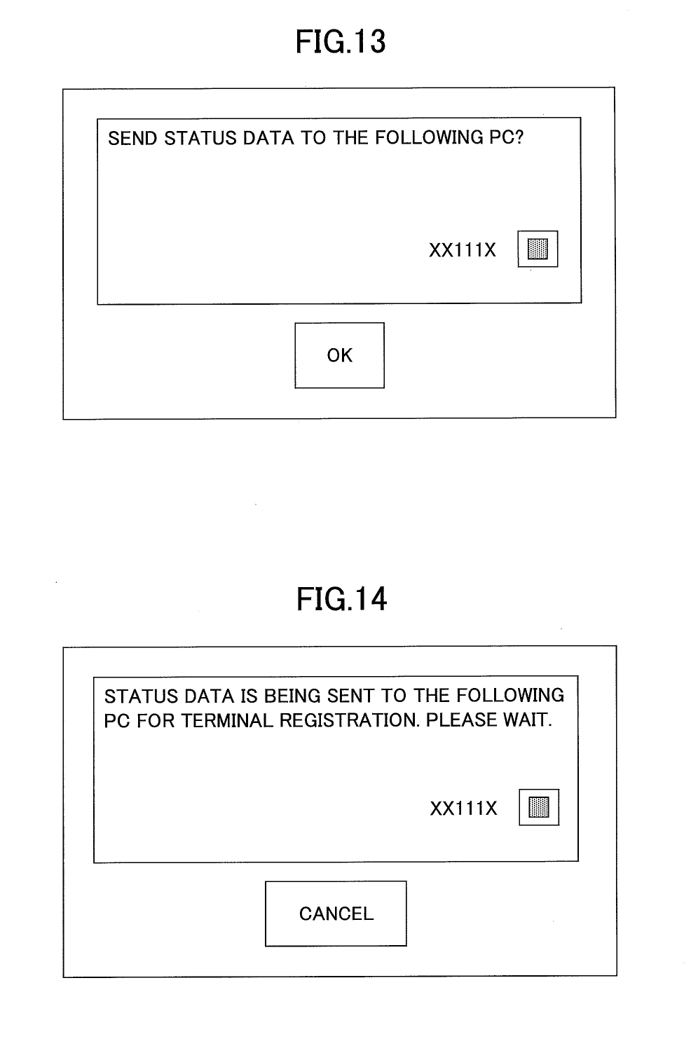

As illustrated by FIG. 12, the registration processor 202 displays the PC selection UI that includes a list of personal computers 10 connected at step S114 and allows an operator to select a personal computer 10 in which status data is to be registered. In the example of FIG. 12, IDs “XX111X”, “YY222Y”, and “ZZ333Z” of three personal computers 10 are displayed on the PC selection UI. Check boxes are provided to the right of the IDs of the personal computers 10 to allow the operator to select one or more of the personal computers 10. In FIG. 12, a personal computer 10 with the ID “XX111X” is selected. The IDs of the personal computers 10 displayed on the PC selection UI may be represented by MAC addresses of the personal computers 10. When the operator selects a personal computer(s) 10 in which status data is to be registered and presses an OK button, a status data transmission confirmation UI is displayed. FIG. 13 is a drawing illustrating an exemplary status data transmission confirmation UI of the terminal 20.

When an OK button is pressed on the status data transmission confirmation UI of FIG. 13, the registration processor 202 sends status data stored in the user information DB 201 to the selected personal computer 10 (S20). FIG. 14 is a drawing illustrating an exemplary status data transmission progress UI of the terminal 20.

While the status data is being sent to the personal computer 10, the status data transmission progress UI of FIG. 14 is displayed on the display 15 of the terminal 20. When the operator presses a Cancel button on the status data transmission progress UI, the transmission of the status data is canceled.

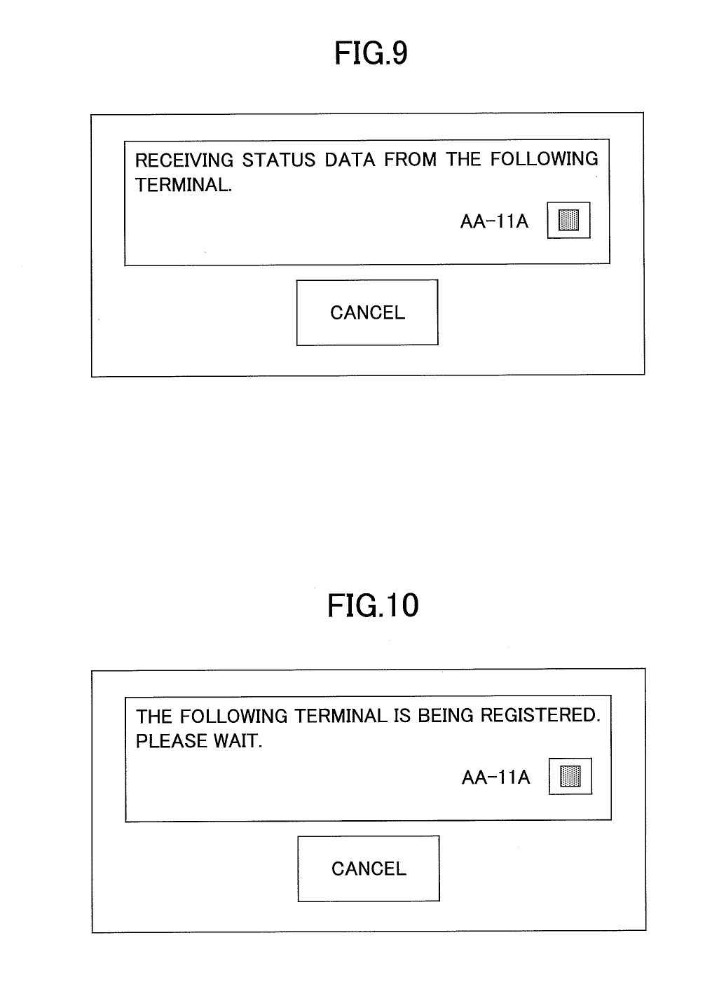

On the other hand, a status data reception UI is displayed on the display 15 of the personal computer 10 receiving the status data. FIG. 9 is a drawing illustrating an exemplary status data reception UI of the personal computer 10.

While the status data is being received from the terminal 20, the authentication application 100 displays the status data reception UI of FIG. 9. When the operator presses a Cancel button on the status data reception UI, the reception of the status data is canceled.

Next, communications between the personal computer 10 and the authentication server 30 at steps S13 through S17 are described.

The authentication application 100 of the personal computer 10 connects to the authentication server 30 using the ID and the password entered on the ID-PW input UI of FIG. 7 (S13).

Next, the authentication application 100 sends a registration request to request the authentication server 30 to register a GIP address of an access point used by the terminal 20 and a user number (S14). The GIP address identifies an access point used by the terminal 20 to access the personal computer 10 in the past.

In response to the registration request from the personal computer 10, the authentication server 30 performs a registration process (S15). Details of the registration process are described with reference to FIG. 6. FIG. 6 is a flowchart illustrating an exemplary registration process performed by the authentication server 30.

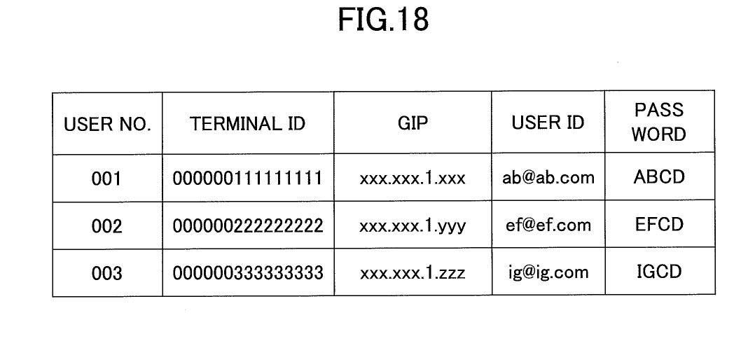

As illustrated by FIG. 6, the management DB 301 of the authentication server 30 receives the registration request from the personal computer 10 (S151). Next, according to the registration request, the management DB 301 registers the GIP address of the access point and the user number of the terminal 20 to be connected with the personal computer 10 via a P2P connection (S152). The management DB 301 of the authentication server 30 is described with reference to FIG. 18. FIG. 18 is a table illustrating an exemplary information structure of the management DB 301.

As illustrated by FIG. 18, a user number, a terminal ID, a GIP address of an access point used most recently by the terminal 20, a user ID, and a password are registered in the management DB 301 through the initial registration process of FIG. 3.

Referring back to FIG. 3, the management DB 301 sends, to the personal computer 10, a response indicating that the registration of the GIP address and the user number has been completed (S16).

When receiving the response at step S16, the personal computer 10 sends a registration request to the authentication server 30 to request the authentication server 30 to register a user ID and a password included in the status data received at step S20 (S17).

Referring to FIG. 6, when the request to register the user ID and the password is received from the personal computer 10 (S153), the management DB 301 determines whether the password is usable (S154). When the password is usable (YES at S154), the management DB 301 registers the user ID and the password (S155), reports the registration result to the personal computer 10 (S156), and ends the registration process of step S15.

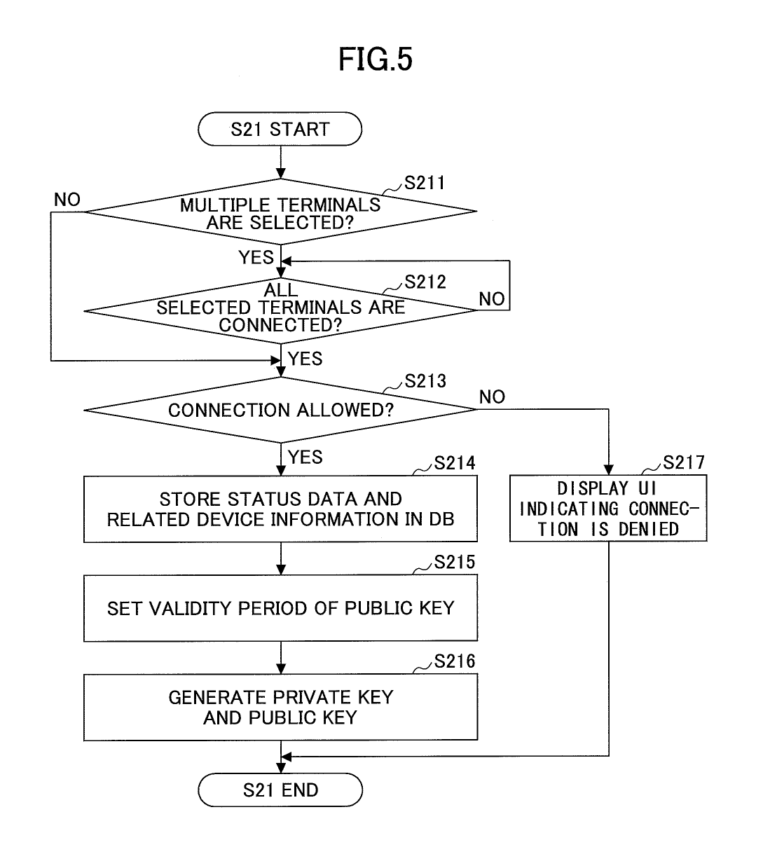

Referring back to FIG. 3, when the Cancel button is not pressed, the authentication application 100 performs a status data registration process to register the received status data (S21). The status data registration process includes a status data validity confirmation process performed by the validity determiner 102, and a private key and public key generation process and a public key validity period registration process performed by the key generator 103. Details of the status data registration process are described with reference to FIG. 5. FIG. 5 is a flowchart illustrating an exemplary status data registration process performed by the personal computer 10.

As illustrated by FIG. 5, the authentication application 100 determines whether multiple terminals 20 have been selected for registration of their status data (S211). The terminals 20 are selected, for example, on the terminal selection UI illustrated by FIG. 8. When multiple terminals 20 have been selected (YES at S211), the authentication application 100 determines whether all of the selected terminals 20 are connected with the personal computer 10, i.e., whether communication channels have been established between the selected terminals 20 and the personal computer 10 at S12 of FIG. 3 (S212). When all of the selected terminals 20 are connected, the authentication application 100 performs a status data validity confirmation process for each terminal 20 whose status data has been received to determine whether the status data is valid and a P2P connection is allowed for the terminal 20 (S213). The status data validity confirmation process is performed to cancel the rest of the status data registration process when, for example, the received status data includes a blank field (or necessary information is missing in the status data), or a password included in the status data does not satisfy predetermined criteria such as a length and types of characters and is weak in terms of security. When the status data registration process is canceled (NO at S213), an unsuccessful validation UI as exemplified by FIG. 16 is displayed on the personal computer 10 (S217).

The unsuccessful validation UI of FIG. 16 indicates that the connection of a selected terminal “AA-11A” is denied. In addition to when the status data registration process is canceled, the unsuccessful validation UI of FIG. 16 may also be displayed when the transmission of status data is not permitted on the status data transmission confirmation UI of FIG. 13 displayed on the terminal 20. When the status data registration process is canceled, a user interface similar to the unsuccessful validation UI of FIG. 16 may also be displayed on the corresponding terminal 20.

On the other hand, when the validity of the status data is confirmed (YES at S213), the authentication application 100 stores the status data and device information of the terminal 20 in the user DB 101 (S214). Next, the key generator 103 of the authentication application 100 generates, for each terminal 20, a pair of a private key and a public key based on the status data received from the corresponding terminal 20. The private key and the public key may be generated using, for example, a part of the status data. Also, the private key and the public key may be generated based on data obtained by applying a hash function to the status data. Because the status data varies depending on the terminal 20 and information on an access point used by the terminal 20, the public key generated by the key generator 103 also varies depending on the status data.

A validity period is set for the public key (S215). For example, an expiration date may be set as the validity period of the public key. Limiting the use of the public key by the expiration date makes is possible to improve security. Also, a start date and time and an end date and time may be set as the validity period. For example, a start date and time and an end date and time of a meeting performed using the personal computer 10 and the terminal 20 may be set as the validity period to improve security. The key generator 103 generates the private key and the public key with the set validity period (S216), and stores the generated private key and public key in the memory 12 of the personal computer 10 together with the status data received from the terminal 20 to register the terminal 20.

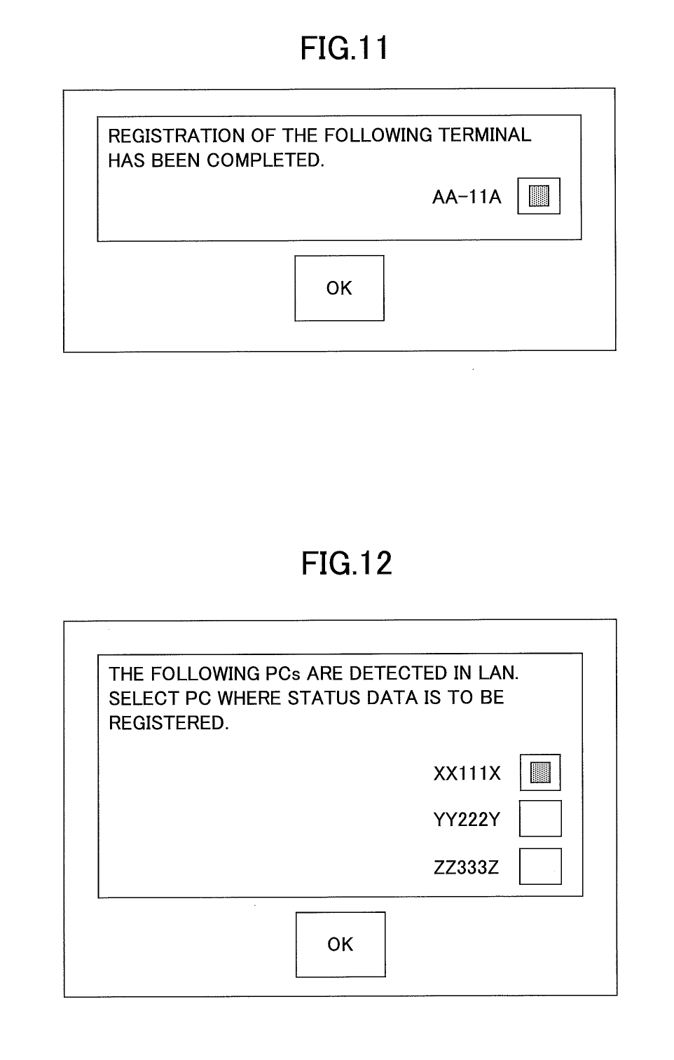

FIG. 10 is a drawing illustrating an exemplary terminal registration progress UI of the personal computer 10. FIG. 11 is a drawing illustrating an exemplary terminal registration completion UI of the personal computer 10.

Referring back to FIG. 3, the generated public key is sent to the corresponding terminal 20 (S22). In the present embodiment, as described above, the initial registration process is performed in a secure network environment. Therefore, the public key can be safely sent to the terminal 20 without encrypting the public key or the communication channel. Also, the public key may be delivered to the terminal 20 at step S22 using a storage medium such as a memory card.

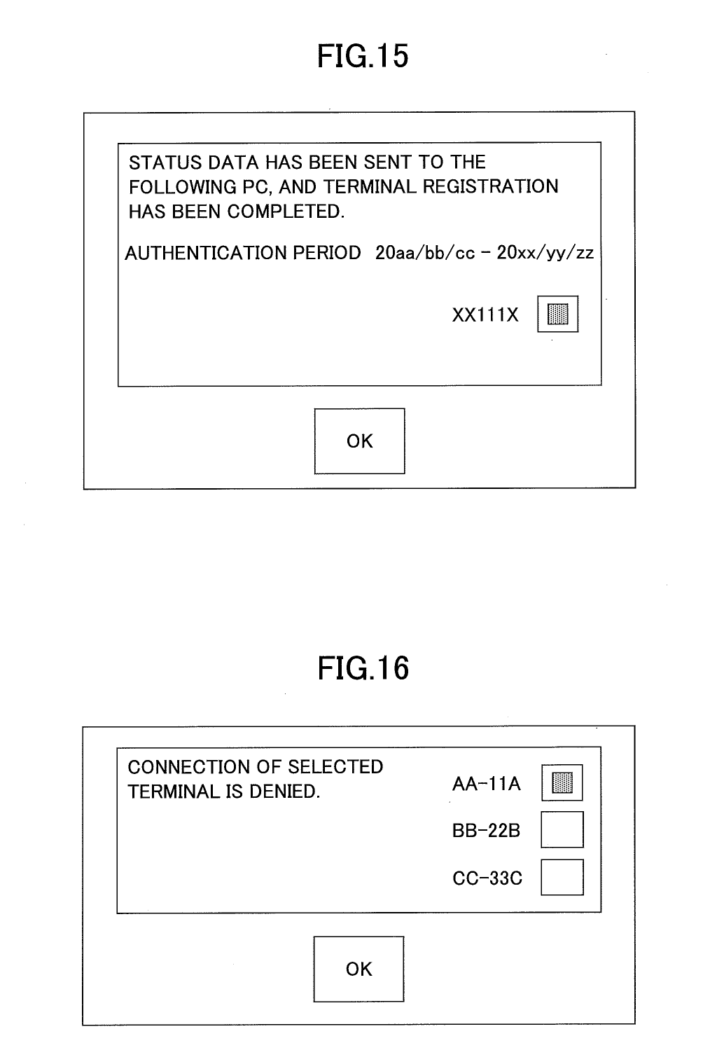

When receiving the public key, the terminal 20 embeds the received public key in the encryptor 203 and sends a public key embedding completion response to the personal computer 10 (S23). FIG. 15 is a drawing illustrating an exemplary registration completion UI of the terminal 20.

Next, the personal computer 10 sends a GIP address of the personal computer 10 to the authentication server 30 (S24). In response, the authentication server 30 sends a GIP registration completion report to the personal computer 10 (S25), and the initial registration process ends. The GIP address sent at step S24 is to be used by the terminal 20 to access the personal computer 10. With the GIP address registered in the authentication server 30, the terminal 20 authenticated by the authentication server 30 can access the personal computer 10 using the GIP address.

In the present embodiment, because the public key is generated through interaction via a direct connection between the personal computer 10 and the terminal 20, the authentication server 30 does not have information on the public key. This in turn makes it possible to secure security even when, for example, the service of the authentication server 30 is provided by an outside supplier.

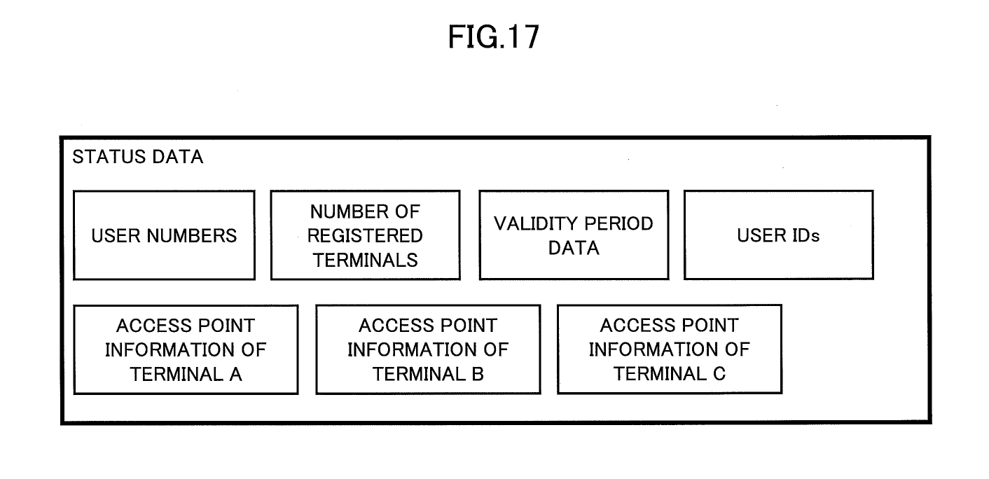

Details of status data registered in the personal computer 10 through the initial registration process are described with reference to FIG. 17. The status data includes validity period data indicating validity periods, and is registered by storing the status data in the user DB 101 of the personal computer 10. FIG. 17 is a drawing illustrating exemplary status data stored in the personal computer 10.

In the example of FIG. 17, the status data includes user numbers, the number of registered terminals, validity period data, user IDs, and access point information of terminals (e.g., access point information of a terminal A, access point information of a terminal B, and access point information of a terminal C). The user numbers are numbers assigned by the personal computer 10 to users of terminals and used in the user DB 101 to identify records of the terminals. For example, user numbers 001, 002, . . . are assigned to users of terminals in the order of registration. The number of registered terminals indicates the number of terminals whose status data is registered in the personal computer 10. The validity period data indicates validity periods of public keys. The user IDs are unique IDs assigned to the users of the terminals.

The access point information of the terminal A indicates an access point used previously by the terminal A to connect to the personal computer 10. For example, the access point information may be represented by an ID or a GIP address of the access point. In the present embodiment, it is assumed that a GIP address is used as the access point information. The access point information may also include a use history indicating, for example, the date and time when the terminal A connected to the access point. Further, the access point information may include information indicating a communication route including the access point. The use history of the access point may include a record of the most recent use of the access point or a predetermined number of records of past use of the access point. Because the access point information varies depending on the use of the access point by a terminal, using the access point information for terminal authentication makes it possible to improve security. The access point information of the terminal B and the access point information of the terminal C are similar to the access point information of the terminal A, and therefore their descriptions are omitted here. As described above, the personal computer 10 stores status data for each of the terminals 20.

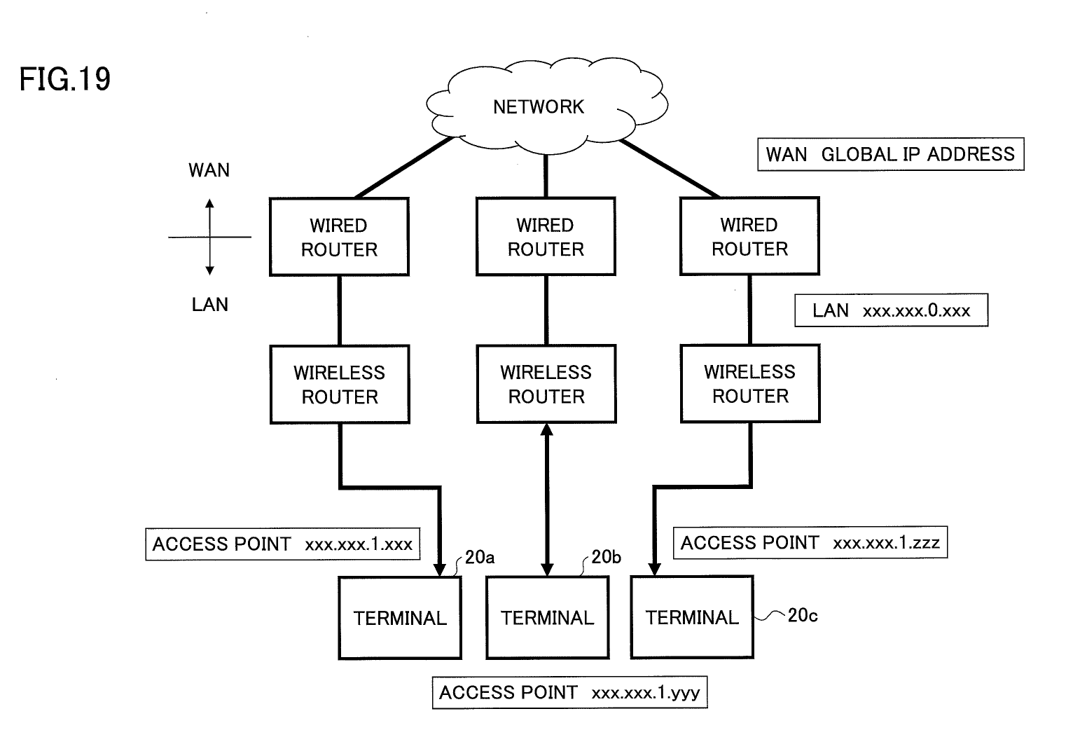

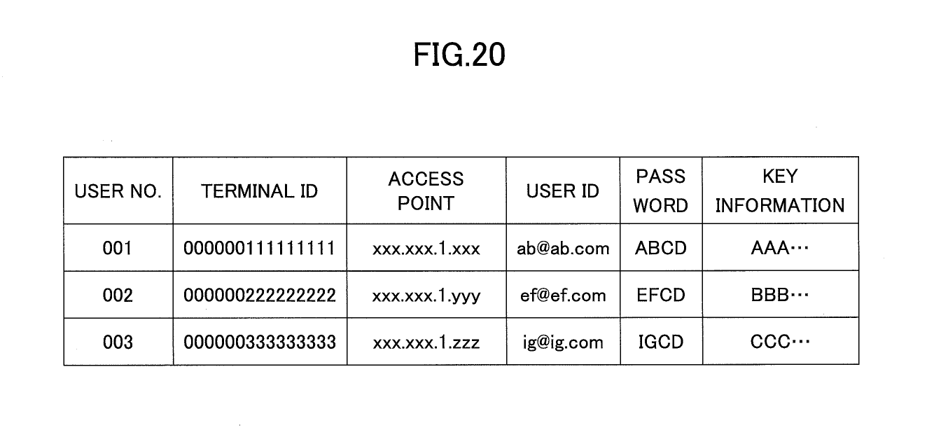

Next, examples of status data generated in the cases of different connection configurations are described with reference to FIGS. 19 through 22. FIG. 19 illustrates an exemplary connection configuration (first connection configuration) where the terminals 20 connect independently to different access points. FIG. 20 is a table illustrating exemplary status data generated in the case of the first connection configuration.

In FIG. 19, a terminal 20a, a terminal 20b, and a terminal 20c are connected to different wireless routers that function as access points, and are connected via wired routers to a public network. Here, it is assumed that the terminal 20a, the terminal 20b, and the terminal 20c are used by different users, and different sets of user IDs and passwords are registered for the terminals 20a, 20b, and 20c. FIG. 20 illustrates exemplary status data generated in the case of the first connection configuration.

In the example of FIG. 20, the status data includes records with user numbers 001, 002, and 003, and each of the records includes a terminal ID, an access point, a user ID, a password, and key information including a pair of a private key and a public key for the corresponding terminal 20. The access point is represented by a private IP address (in this example, “xxx.xxx.1.xxx”, “xxx.xxx.1.yyy”, or “xxx.xxx.1.zzz”) assigned by the corresponding wireless router. The key generator 103 of the personal computer 10 generates a private key and a public key for each terminal 20 based on status data that includes an access point and sent from the terminal 20. Accordingly, the key information (the private key and the public key) is stored in each record in association with the corresponding user number.

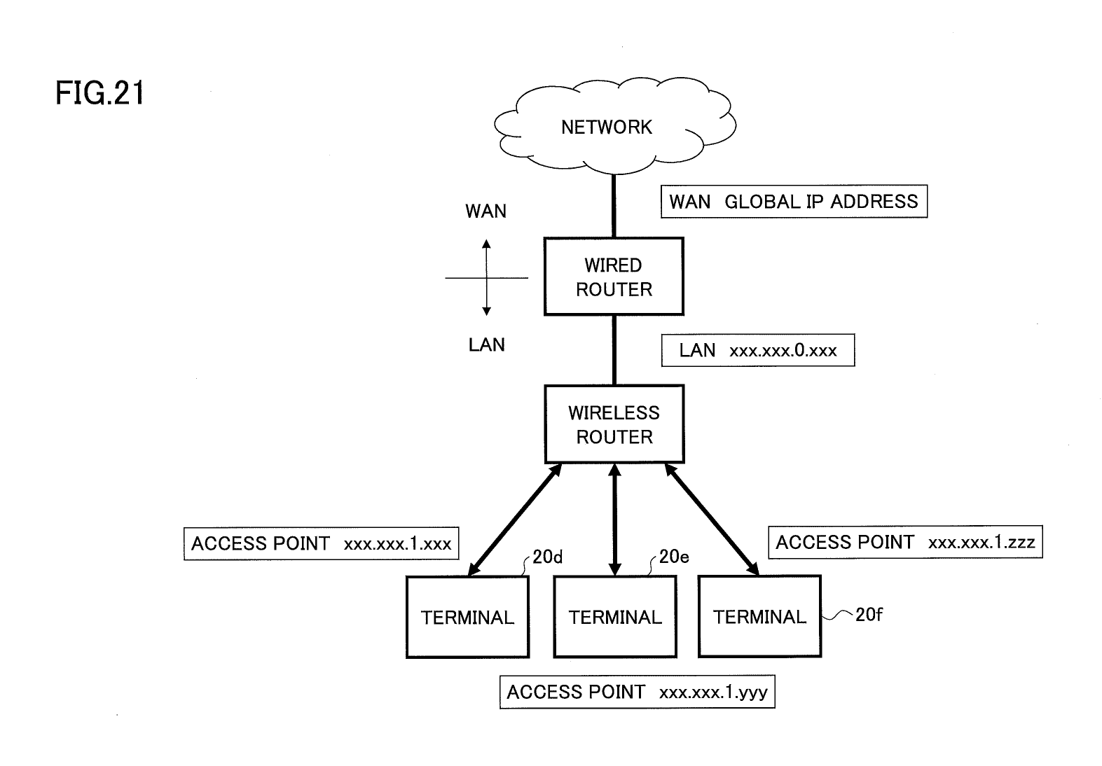

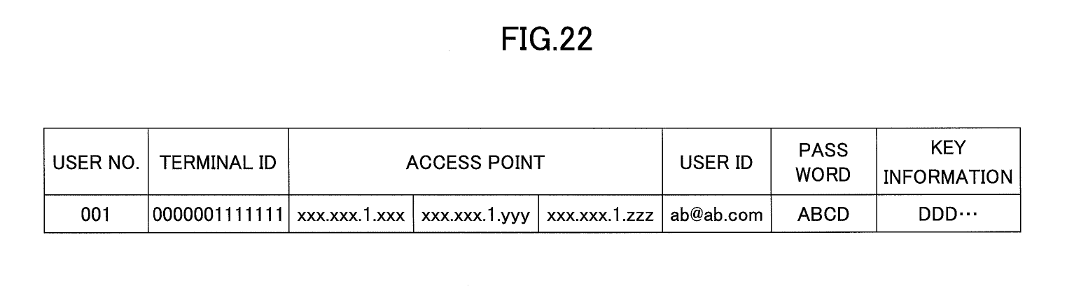

FIG. 21 illustrates an exemplary connection configuration (second connection configuration). FIG. 22 is a table illustrating exemplary status data generated in the case of the second connection configuration. In the second connection configuration, as in a case of a meeting using multiple terminals 20, the terminals 20 are connected concurrently to an access point.

In the second connection configuration of FIG. 21, the terminals 20 use the same wireless router as an access point. Also in this example, all the terminals 20 are connected to a public network via the same communication route including the wireless router and a wired router. In the case of the second connection configuration, as illustrated by FIG. 22, the status data includes one record including one user number, one terminal ID, and three IP addresses of terminals 20d, 20e, and 20f as access points. The key generator 103 generates one pair of a private key and a public key based on the three IP addresses, and stores key information indicating the generated private key and public key in the record. Each of the terminals 20d, 20e, and 20f performs public key encryption by using its own IP address.

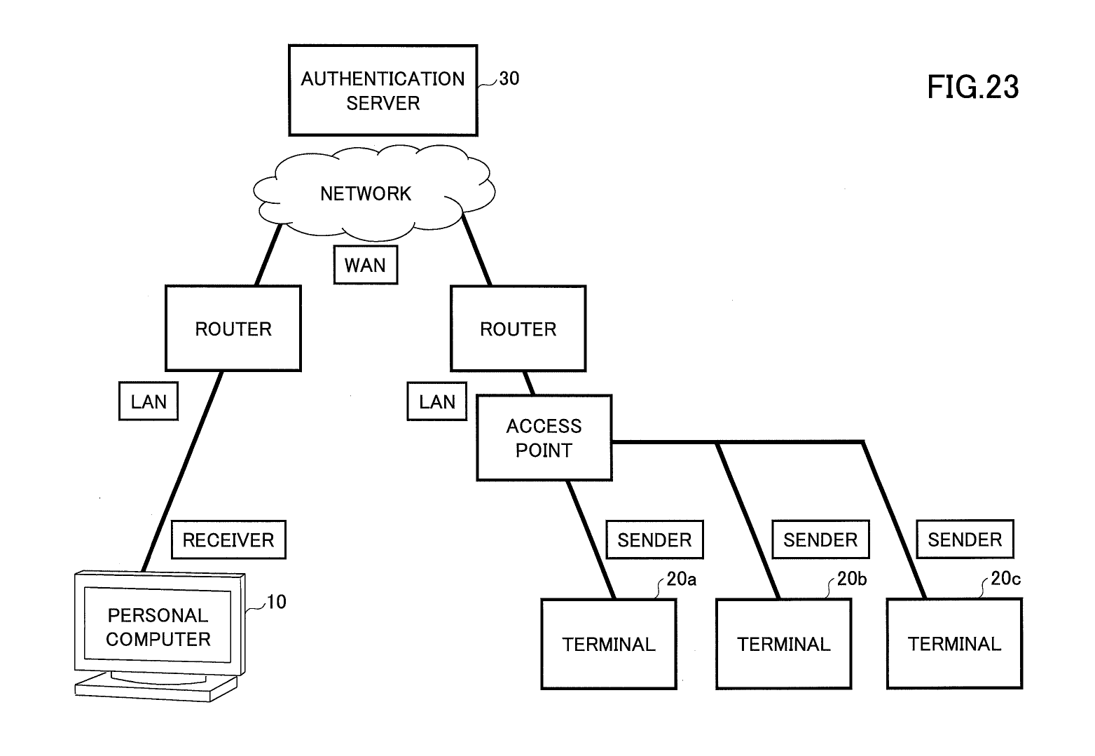

Next, an exemplary connection configuration of the personal computer 10, the terminals 20, and the authentication server 30 for a hybrid P2P connection is described with reference to FIG. 23. FIG. 23 is a drawing illustrating an exemplary connection configuration for a hybrid P2P connection. In FIG. 23, the personal computer 10 is provided in a LAN and is connected via a router to a wide area network (WAN). Terminals 20a, 20b, and 20c (terminals 20) provided in another LAN are connected to an access point, and are further connected via a router to the WAN. The authentication server 30 is provided in the WAN, and is accessible from the personal computer 10 and the terminals 20. Here, the WAN indicates a public telecommunication network such as the Internet, and communication channels in the WAN are not necessarily in a secure network environment.

In the present embodiment, it is assumed that a use history of the access point is shared by the personal computer 10 and the terminals 20, a generated public key is registered in each of the terminals 20 in advance, and the personal computer 10 and the terminals 20 perform P2P communications.

Through the initial registration process described above, a private key and a public key are registered in the personal computer 10, and the public key is registered in each terminal 20. The terminal 20 establishes a communication channel with the personal computer 10 by using the public key registered in the initial registration process. Here, the authentication server 30 is present on a public telecommunication network, and may be operated by a third party. However, because the public key is generated in the initial registration process without involving the authentication server 30, the authentication server 30 does not have information on the public key and cannot establish a communication channel with the personal computer 10 using the public key. That is, the authentication server 30 can only access the personal computer 10 using the GIP address of the personal computer 10. Accordingly, even when, for example, a malicious program is executed on the authentication server 30 or the authentication server 30 is operated by a malicious administrator, it is not possible to establish a P2P connection between the authentication server 30 and the personal computer 10.

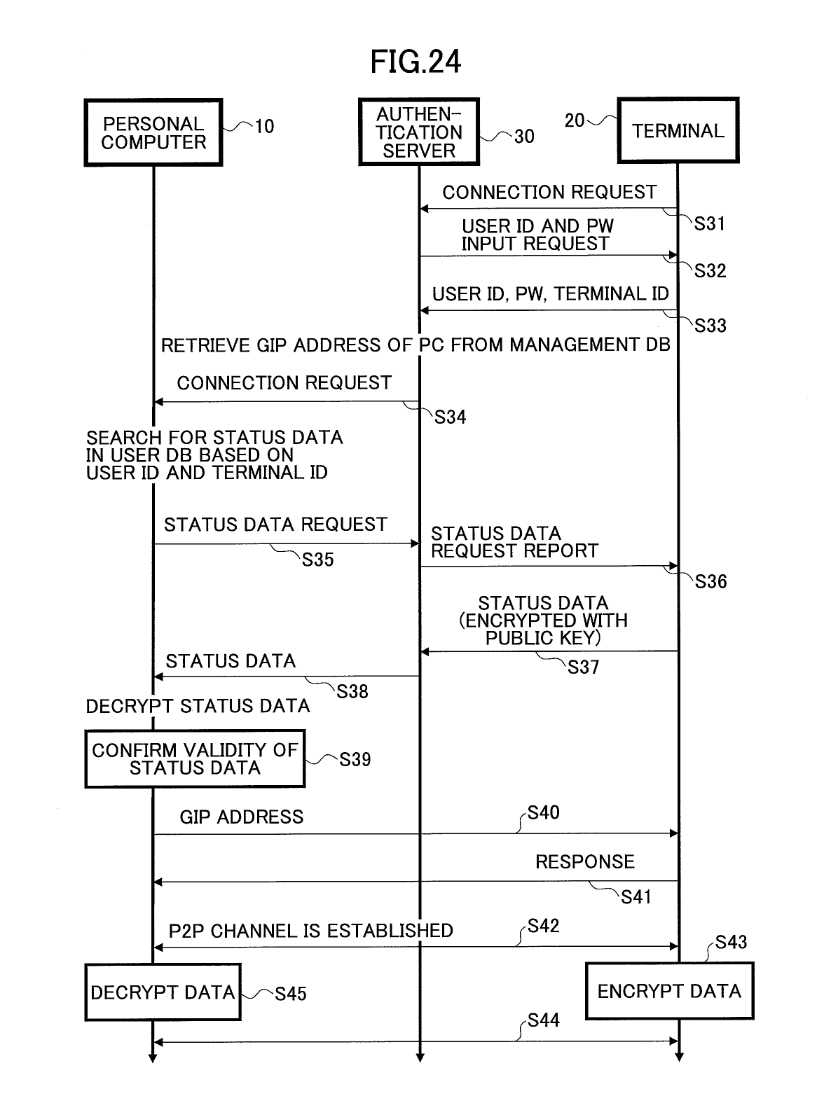

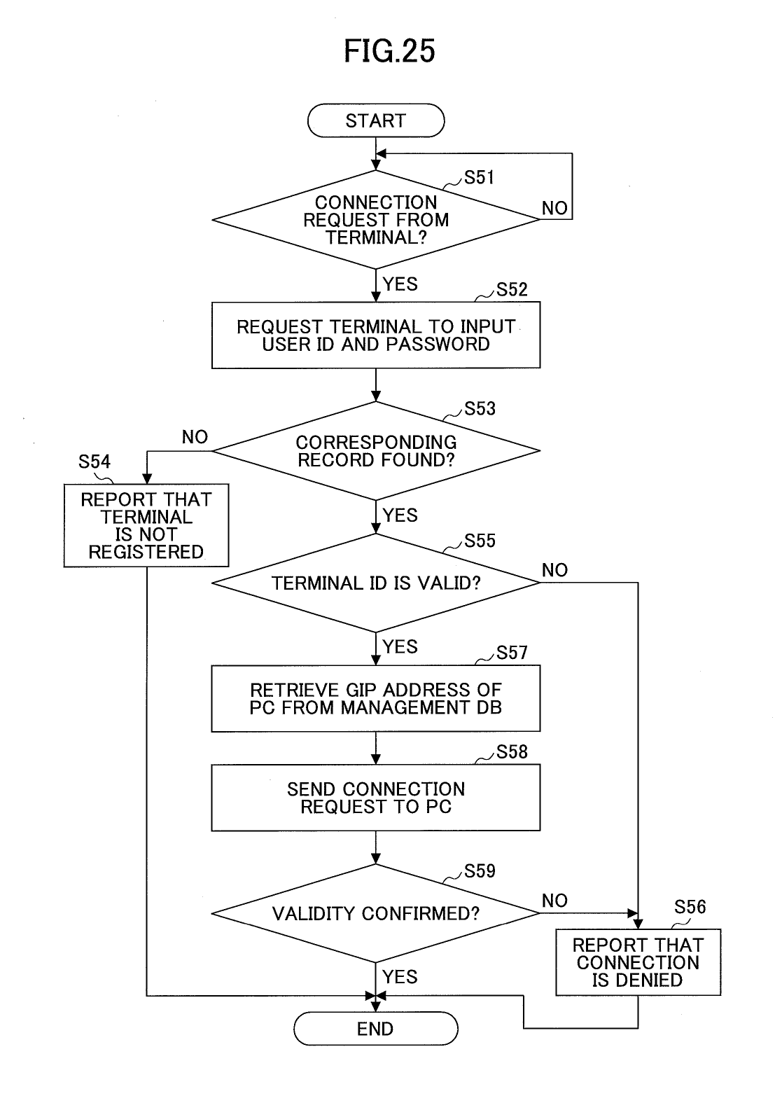

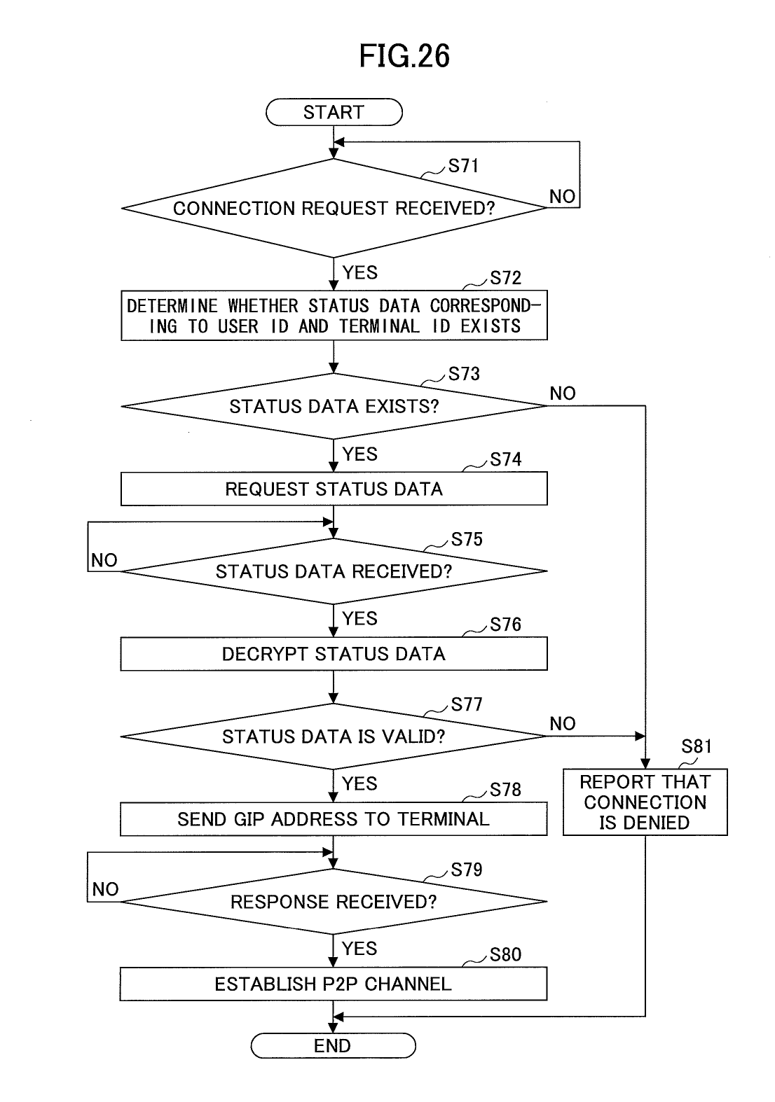

Next, an exemplary process performed to establish a hybrid P2P channel is described with reference to FIGS. 24 through 26. FIG. 24 is a sequence chart illustrating an exemplary process performed to establish a hybrid P2P channel. FIG. 25 is a flowchart illustrating an exemplary process performed by the authentication server 30 in the process of establishing a hybrid P2P channel. FIG. 26 is a flowchart illustrating an exemplary process performed by the personal computer 10 in the process of establishing a hybrid P2P channel.

In FIG. 24, the terminal 20 sends a connection request to the authentication server 30 to request a connection to the personal computer 10 (S31). Here, as described with reference to FIG. 23, it is assumed that the authentication server 30 is provided on a public network accessible from the terminal 20, and the GIP address of the authentication server 30 is set in advance in the terminal 20. Also, the GIP address of the authentication server 30 may be obtained by the terminal 20 from, for example, a domain name system (DNS) server managing the GIP address.

In FIG. 25, when receiving the connection request (YES at S51), the authentication server 30 requests the terminal 20 to input a user ID and a password (S52, S32).

In response, the terminal 20 sends, to the authentication server 30, status data that includes a user ID, a password, a terminal ID, and access point information and is encrypted by a public key (S33).

The searcher 302 of the authentication server 30 searches status data stored in the management DB 301 to determine whether the status data includes a record including the user ID and the password sent from the terminal 20 (S53). When no record including the user ID and the password is found (NO at S53), the searcher 302 reports to the terminal 20 that the terminal 20 has not been registered (S54), and ends the process of FIG. 25. On the other hand, when a record including the user ID and the password is found (YES at S53), the searcher 302 determines whether the terminal ID is valid (S55).

When the terminal ID is valid (YES at S55), the authentication server 30 retrieves a GIP address of the personal computer 10 from the management DB 301 (S57), and sends the connection request received from the terminal 20 to the personal computer 10 together with the user ID and the terminal ID (S58, S34).

In FIG. 26, when receiving the connection request, the user ID, and the terminal ID from the authentication server 30 (YES at S71), the personal computer 10 determines whether status data corresponding to the received user ID and terminal ID exists in the user DB 101 (S72). When status data corresponding to the received user ID and terminal ID exists in the user DB 101 (YES at S73), the personal computer 10 requests the authentication server 30 to send status data of the terminal 20 (S74, S35). The personal computer 10 waits for reception of status data (S75).

When requested by the personal computer 10 to send status data (S35), the authentication server 30 sends a status data request report to the terminal 20 (S36).

The terminal 20 sends, to the authentication server 30, status data that includes access point information and is encrypted by the public key (S37).

The authentication server 30 sends the status data received from the terminal 20 to the personal computer 10 (S38).

When the status data is received by the personal computer 10 (YES at S75), the encryptor-decryptor 104 of the authentication application 100 decrypts the received status data with a private key corresponding to the user ID in the received status data (S76). Next, the validity determiner 102 compares the access point information in the decrypted status data with access point information in the corresponding status data stored in the user DB 101 to determine the validity of the decrypted status data (S77, S39). When the decrypted status data is valid (YES at S77), the personal computer 10 sends its own GIP address via the authentication server 30 or directly to the terminal 20 (S78, S40).

Also when the status data is valid (YES at S59), the authentication server 30 ends the process of FIG. 25. When the terminal ID is invalid (NO at S55) or the validity of the status data is not confirmed (NO at S59), the authentication server 30 reports to the terminal 20 that connection of the terminal 20 is denied (S56), and ends the process of FIG. 25.

When receiving the GIP address of the personal computer 10 (S40), the terminal 20 sends a response to the personal computer 10 using the received GIP address (S41).

When receiving the response from the terminal 20 (YES at S79), the personal computer 10 establishes a P2P channel (S80, S42), and ends the process of FIG. 26.

On the other hand, when status data corresponding to the received user ID and terminal ID does not exist in the user DB 101 (NO at S73) or when the decrypted status data is not valid (NO at S77), the personal computer 10 reports to the authentication server 30 that connection of the terminal 20 is denied (S81), and ends the process of FIG. 26.

When the P2P channel is established, the personal computer 10 and the terminal 20 start P2P communications. For example, the terminal 20 encrypts data with the public key (S43) and sends the encrypted data to the personal computer 10 (S44). Then, the personal computer 10 decrypts the data received from the terminal 20 (S45), and uses the decrypted data.

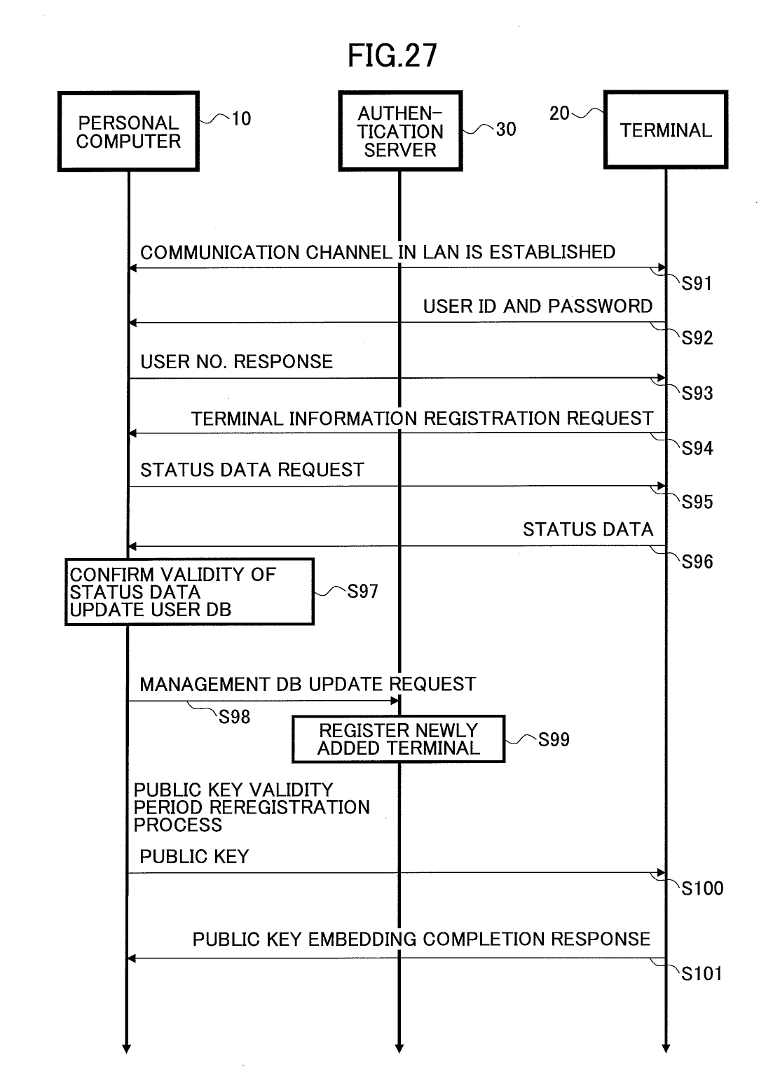

Next, an exemplary process performed by a registered user after the initial registration process to register an additional terminal is described with reference to FIG. 27. FIG. 27 is a sequence chart illustrating an exemplary additional terminal registration process. The process of FIG. 27 is different from the process of FIG. 3 mainly in that the user has already been registered in the personal computer 10, and the user DB 101 of the personal computer 10 and the management DB 301 of the authentication server 30 are updated to register an additional terminal 20. Therefore, descriptions of steps of FIG. 27 similar to those of FIG. 3 are omitted.

In FIG. 27, after a communication channel in a LAN is established (S91), the terminal 20 accesses the personal computer 10 using a user ID and a password that have already been registered (S92). The personal computer 10 searches the user DB 101 to find a user corresponding to the user ID and the password. When a user corresponding to the user ID and the password is found in the user DB 101, the personal computer sends a user NO. response to the terminal 20 (S93). When receiving the user NO. response, the terminal 20 sends a terminal information registration request to the personal computer 10 (S94). When receiving the terminal information registration request, the personal computer 10 sends a status data request to the terminal 20 (S95). In response to the status data request, the terminal 20 sends status data to the personal computer 10 (S96).

The personal computer 10 determines whether the status data is valid, and updates the user DB 101 when the status data is valid (e.g., stores the status data and device information of the terminal 20 in the user DB 101) (S97). Also, the personal computer 10 requests the authentication server 30 to update the management DB 301 (S98). When requested, the authentication server 30 newly registers the terminal 20 in the management DB 301 (S99).

Next, the personal computer 10 registers the validity period of the public key again. The validity period of the public key registered at this step may be different from the validity period of another public key already registered. Also, the validity period of the public key may be the same as the validity period of an already-registered public key associated with the same user ID. Further, the validity period of an already-registered public key may be extended so that public keys of all the terminals 20 registered in association with the same user ID have the same validity period.

The personal computer 10 sends the public key to the terminal 20 (S100). The terminal 20 embeds the public key in the encryptor 203 and sends a public key embedding completion response to the personal computer 10 (S101).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a storage that stores status data indicating past usage of an access point by a terminal; and
a processor that executes a process including
receiving encrypted status data via a network from the terminal,
decrypting the encrypted status data received from the terminal,
determining whether the decrypted status data is valid based on the status data stored in the storage, and
when the decrypted status data is valid, establishing a peer-to-peer communication channel with the terminal via the network.

2. The information processing apparatus as claimed in claim 1, wherein
the process further includes generating a public key and a private key based on the status data stored in the storage;
the encrypted status data is status data encrypted by the terminal using the public key; and
in the decrypting, the encrypted status data is decrypted using the private key.

3. The information processing apparatus as claimed in claim 1, wherein the process further includes
receiving the status data to be stored in the storage from the terminal in a secure network environment.

4. The information processing apparatus as claimed in claim 2, wherein the process further includes
sending the public key to the terminal in a secure network environment.

5. A terminal, comprising:
a processor that executes a process including
registering status data indicating past usage of an access point by the terminal;
encrypting the registered status data;
sending the encrypted status data via a network to an information processing apparatus; and
when the encrypted status data is determined to be valid by the information processing apparatus, establishing a peer-to-peer communication channel with the information processing apparatus.

6. The terminal as claimed in claim 5, wherein the process further includes
sending the registered status data to the information processing apparatus in a secure network environment.

7. The terminal as claimed in claim 6, wherein in the encrypting, the registered status data is encrypted using a public key that is generated by the information processing apparatus based on the registered status data sent from the terminal in the secure network environment.

8. The terminal as claimed in claim 7, the process further includes
receiving the public key from the information processing apparatus in the secure network environment.

9. An information processing system, comprising:
an information processing apparatus; and
a terminal,
wherein the information processing apparatus includes
a storage that stores status data indicating past usage of an access point by the terminal, and
a first processor that executes a first process including
receiving encrypted status data via a network from the terminal,
decrypting the encrypted status data received from the terminal, and
determining whether the decrypted status data is valid based on the status data stored in the storage;
wherein the terminal includes
a second processor that executes a second process including
registering the status data indicating the past usage of the access point by the terminal,
encrypting the registered status data, and
sending the encrypted status data via the network to the information processing apparatus; and
wherein when the decrypted status data is determined to be valid in the first process, the information processing apparatus and the terminal establish a peer-to-peer communication channel between the information processing apparatus and the terminal.

10. The information processing system as claimed in claim 9, wherein
the first process further includes generating a public key and a private key based on the status data stored in the storage;
in the encrypting, the terminal encrypts the registered status data using the public key generated by the information processing apparatus; and
in the decrypting, the information processing apparatus decrypts the encrypted status data using the generated private key.

11. The information processing system as claimed in claim 9, wherein
the second process further includes sending the registered status data to the information processing apparatus in a secure network environment; and
the first process further includes receiving the registered status data to be stored in the storage from the terminal in the secure network environment.

12. The information processing system as claimed in claim 10, wherein
the first process further includes sending the public key to the terminal in a secure network environment; and
the second process further includes receiving the public key from the information processing apparatus in the secure network environment.

13. A method performed by an information processing apparatus and a terminal, the method comprising:
registering, by the terminal, status data indicating past usage of an access point by the terminal;
storing, by the information processing apparatus, the status data indicating the past usage of the access point by the terminal in a storage;
encrypting, by the terminal, the registered status data;
receiving, by the information processing apparatus, the encrypted status data via a network from the terminal;
decrypting, by the information processing apparatus, the encrypted status data received from the terminal;
determining, by the information processing apparatus, whether the decrypted status data is valid based on the stored status data; and
when the decrypted status data is valid, establishing, by the information processing apparatus and the terminal, a peer-to-peer communication channel between the information processing apparatus and the terminal.

14. The method as claimed in claim 13, further comprising:
generating, by the information processing apparatus, a public key and a private key based on the stored status data,
wherein
in the encrypting, the terminal encrypts the registered status data using the public key generated by the information processing apparatus; and
in the decrypting, the information processing apparatus decrypts the encrypted status data using the generated private key.

15. The method as claimed in claim 13, further comprising:
sending, by the terminal, the registered status data to the information processing apparatus in a secure network environment; and
receiving, by the information processing apparatus, the registered status data to be stored in the storage from the terminal in the secure network environment.

16. The method as claimed in claim 14, further comprising:
sending, by the information processing apparatus, the public key to the terminal in a secure network environment; and
receiving, by the terminal, the public key from the information processing apparatus in the secure network environment.
